(19) United States
(12) Patent Application Publication
(10) Pub. No.: US 2007/0080036 A1
(43) Pub. Date: Apr. 12, 2007

(54) Electromagnetic Coupling Device Having Conducting Bearing And Lubricant

(75) Inventors: Larry Elie, Ypsilanti, MI (US); Clay Maranville, Ypsilanti, MI (US); John Ginder, Plymouth, MI (US)

Correspondence Address: BIR LAW, PLC/FGTL, 13092 GLASGOW CT., PLYMOUTH, MI, 48170-5241, US

(73) Assignee: FORD GLOBAL TECHNOLOGIES, LLC, Dearborn, MI (US)

(21) Appl. No.: 11/163,173

(22) Filed: Oct. 7, 2005

(51) Int. Cl. F16D 35/02; F16D 27/02

(52) U.S. Cl. 192/21.5; 192/84.951

(57) ABSTRACT

An electromagnetic coupling device includes a rotating member having an embedded coil positioned to provide a magnetic flux path through the rotating member while substantially eliminating at least one air gap to improve efficiency. At least one bearing or bushing assembly disposed between the rotating member and a second member includes an electrically conductive lubricant to supply electrical current through the assembly and lubricant to the embedded coil during actuation of the device. A method of making an electromagnetic coupling device includes embedding a coil within a rotating member such that the rotating member contacts substantially the entire outer surface of the coil to provide an efficient magnetic flux path and thermal conductivity for heat dissipation through the rotating member and connecting the embedded coil to at least one conductive bearing assembly having conductive lubrication grease.

### BACKGROUND OF THE INVENTION

1. Field of the Invention

The present invention relates to electromagnetic coupling devices.

2. Background Art

An electromagnetic (EM) coupling device may be used as a clutch or brake to selectively couple a rotating component to either another rotating component (operating as a clutch), or to a stationary component (operating as a brake). EM clutches/brakes require a wire coil to be energized by an external source of electric current to create a magnetic field used to couple the components. EM clutch/brake designs include either a rotating coil embedded in one of the rotating members, or a stationary coil placed between the selectively coupled members. In general, rotating coil designs have a more efficient magnetic flux path, but must be connected to the electric current source using brushes or slip-rings. These components add to the device complexity, cost, and part count, and can have durability issues. Alternatively, stationary coil designs have a less efficient magnetic flux path that must traverse at least one, and typically two, air gaps and therefore require expensive precision machining to minimize the air gap while still providing sufficient clearance to accommodate the rotating member(s). In addition, the small air gaps that are desirable in terms of magnetic permeability are not amenable to forced-air cooling and reduce the thermal or heat conduction efficiency of internal components, imposing additional constraints on applications, particularly those that must tolerate slip and generate significant heat in the process.

### SUMMARY OF THE INVENTION

An electromagnetic coupling device includes a rotating member having an embedded coil positioned to provide a magnetic flux path through the rotating member to substantially eliminate at least one air gap. At least one bearing assembly disposed between the rotating member and a second member includes an electrically conductive lubricant to supply electrical current through the bearing and lubricant to the embedded coil during actuation of the device. A method of making an electromagnetic coupling device includes embedding a coil within a rotating member such that the rotating member contacts substantially the entire outer surface of the coil to provide an efficient magnetic flux path through the rotating member, and connecting the embedded coil to at least one conductive bearing assembly having conductive lubricating grease to provide electric current to the embedded coil. A method for selectively coupling a rotating member to a second member includes selectively supplying an electric current to a coil embedded in the rotating member through a conductive bearing having a plurality of rolling elements surrounded by electrically conductive lubricant wherein the coil is substantially surrounded by the rotating member to reduce or eliminate air gaps between the coil and the rotating member and improve effective magnetic permeability of an associated magnetic flux path through the rotating member.

Embodiments of the present invention include an electromagnetic friction clutch, and a magnetorheological (MR) fluid or magnetic particle/powder clutch. The clutches include a rotating member with a coil embedded therein such that the rotating member surrounds and contacts substantially the entire outer surface of the coil. The coil is connected via a first wire lead to a selectively actuated current source through a first bearing assembly having a conductive lubricant and rolling elements between an outer and inner race and sealed cage. In one embodiment, a return current path for the coil is provided by a second wire lead connected through a second bearing assembly electrically isolated/insulated from the first bearing assembly. In another embodiment, the return current path passes to ground through a conductive device mount or mounting assembly, such that only a single conductive bearing assembly is required for actuation.

The present invention provides a number of advantages. For example, the present invention reduces part count and variable cost by using conductive lubricating grease in a bearing to provide a direct electrical conduction path to a rotating electromagnetic coil. Elimination of parts, such as brushes and slip rings may substantially improve reliability and durability. Use of a rotating coil according to the present invention allows embedding of the coil within one of the rotating members to eliminate air gaps in the magnetic flux path to improve magnetic and corresponding electric efficiency. Improved electric efficiency facilitates use of a smaller, lighter coil, and lower power requirements with less generated heat. Elimination of air gaps reduces manufacturing costs by eliminating tight-tolerance machining operations and also improves heat conduction and clutch cooling such that higher slip tolerances may be accommodated for MR fluid and magnetic power clutch applications.

The above advantages and other advantages and features of the present invention will be readily apparent from the following detailed description of the preferred embodiments when taken in connection with the accompanying drawings.

### BRIEF DESCRIPTION OF THE DRAWINGS

FIG. 1 is a split-view cross-section illustrating operation and construction of an electromagnetic friction clutch embodiment of a coupling device according to the present invention; and

FIG. 2 is a cross-section illustrating operation and construction of a magnetorheological (MR) fluid or magnetic particle/powder clutch embodiment of a coupling device according to the present invention.

### DETAILED DESCRIPTION OF THE PREFERRED EMBODIMENT(S)

As those of ordinary skill in the art will understand, various features of the present invention as illustrated and described with reference to any one of the Figures may be combined with features illustrated in one or more other Figures to produce embodiments of the present invention that are not explicitly illustrated or described. The combinations of features illustrated provide representative embodiments for typical applications. However, various combinations and modifications of the features consistent with the teachings of the present invention may be desired for particular applications or implementations.

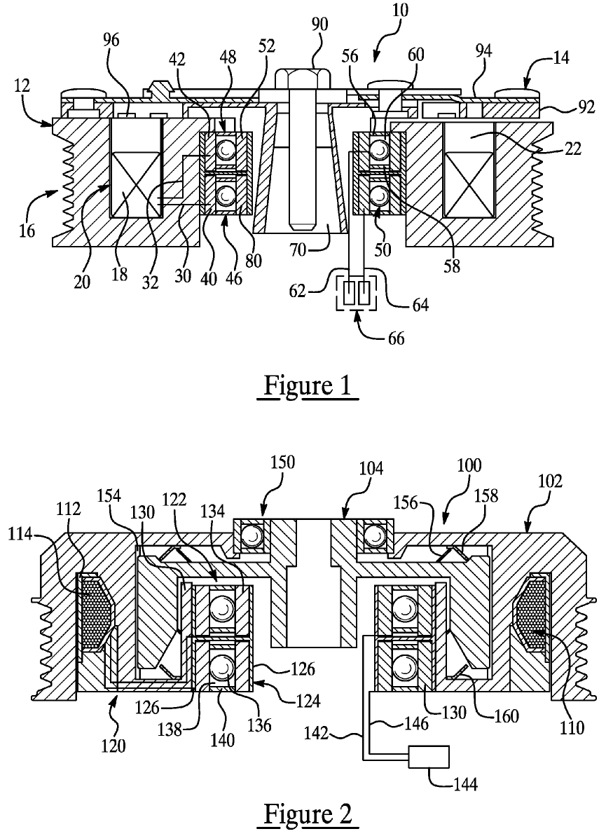

FIG. 1 is a split-view cross-section illustrating operation and construction of an electromagnetic friction clutch embodiment of an electromagnetic coupling device according to the present invention. As previously described, an electromagnetic coupling device according to the present invention may be used to selectively couple two rotating components when operating in a clutch application, or to couple a rotating component to a stationary component when operating in a brake application. In general, the operating principles and basic construction of the coupling device is the same for clutch and brake applications, although components may vary in size and materials depending on the particular application and implementation.

The electromagnetic clutch embodiments illustrated in FIGS. 1 and 2 may be used in a number of applications to selectively couple a driving component to a driven component. Those of ordinary skill in the art will recognize a number of applications for an electromagnetic clutch/brake having conductive lubricant in a conductive bearing or bushing assembly according to the present invention. Representative automotive applications include, but are not limited to clutches for an air conditioning compressor, cooling fan, supercharger, pressure wave supercharger, transmission torque converter lock-up, main internal combustion engine, power take-off (PTO), front end accessory drive (FEAD), water pump, power steering, belt/chain tensioner for FEAD or cam drive, and over running clutch for an alternator. Other automotive applications may include use in a differential lock/torque management system, central differential for a four-wheel-drive vehicle, torque vectoring, inertia management for matching speed in an automatic shifting manual transmission, oversized synchromesh, control of accessory drive through a differential, torque controlled transmission, hybrid drive, magnetorheological rotary shock absorber, engine brake, wheel brakes or connecting sensors of rotating components/elements. The present invention may also be used in a number of industrial applications that include, but are not limited to, tool brakes (lathe, mill, etc.), saw/cutter/sander/router brakes, tensioners for winding (drawing cables, paper reels, etc.), shaft position locks, conveyance brakes, accessory/PTO drives, inertial management brakes for industrial and farm equipment, blake brake for mowing machines, resistance machines (exercise equipment), industrial motor/generators, turbine engines, and feedback control circuit connections. Although the geometry may differ in each of the devices, all clutch/brake applications use a controllable magnetic field that spans the driving and driven components to couple the components when the device is actuated. Other applications use the conductive lubricant to provide volume conductivity rather than a point contact for a rotating component or element.

As illustrated in FIG. 1, an electromagnetic friction clutch embodiment of coupling device 10 includes a driving member 12 that is selectively coupled to a driven member 14 during actuation of device 10. Those of ordinary skill in the art will recognize that the designation as a driving or driven member is a relative functional designation for ease of description in a particular application. For other applications, the role of the driving and driven members may be reversed. The split-view of FIG. 1 includes a left-side view showing coupling device 10 in an engaged position with driving member 12 in contact with driven member 14, and a right-side view showing coupling device 10 in a disengaged position with a small space between driving member 12 and driven member 14.

In the embodiment of FIG. 1, driving member 12 is a pulley having a plurality of “V” grooves 16 to facilitate engagement with a corresponding belt (not shown) that drives or rotates driving member 12 during operation. Driven member 14 may be connected to a shaft 70 to provide selective rotation of the shaft when device 10 is engaged as described in greater detail below. Depending on the particular application and implementation, driving member 12 and/or driven member 14 may be implemented by or connected to pulleys, gears, shafts, etc.

Driving or rotating member 12 includes an embedded coil 18 having an outer surface 20 substantially entirely contacting a corresponding annular pocket or groove in member 12. In contrast to conventional fixed coil EM clutches, the present invention eliminates at least one air gap by embedding coil 18 within rotating member 12 and inserting a cover or cap 22 made of a material having desired magnetic properties that may be the same or different from the material used for other portions of driving member 12. Elimination of the air gap in the magnetic flux path of coil 18 through driving member 12 that is otherwise required for fixed coil implementations to allow rotation of rotating member 12 relative to the coil improves the magnetic and corresponding electric efficiency of EM coupling device 10. As such, reducing the number of air gaps by substantially eliminating any air gaps between coil 18 and driving member 12 requires less power to achieve a given magnetic field in the torque generating portions of device 10 relative to stationary coil designs or other designs that incorporate one or more air gaps in the magnetic flux path.

Rotating embedded coil 18 is electrically connected by first and second wire leads 30, 32 to corresponding electrically conductive outer races 40, 42 of conductive bearing assemblies 46, 48, respectively. Routing of wire leads 30, 32 to outer races 40, 42 is schematically illustrated for ease of description with actual placement or routing selected based on various application and implementation specific considerations. Outer races 40, 42 may engage rotating member 12 with an interference or press fit such that outer races 40, 42 rotate with rotating member 12 during operation. Each conductive bearing assembly 46, 48 includes a plurality of rolling elements 50 implemented by bearing balls in this embodiment. Rolling elements 50 may also be implemented by cylindrical elements, typically referred to as needle or roller bearings. Rolling elements 50 are disposed between an inner race 52 and corresponding outer race 42 with bearing balls 50 surrounded by an electrically conductive lubricant or lubricating grease 60 contained by upper and lower cages and/or seals 56, 58, respectively. Electrically conductive grease 60 should be capable of conducting an electric current capable of generating a magnetic field suitable to operate device 10 without significantly degrading or arcing. For a representative automotive application, electrically conductive lubricant 60 may have a volume resistivity of less than or equal to about 300 ohm-cm and be able to sustain a current of at least about four amperes. One such suitable lubricant is Nyogel 758G, which is commercially available from NYE Lubricants, Inc. of Fairhaven, Mass. Electrically conductive lubricant 60 provides a sufficient current carrying capacity and reduces or eliminates arcing between components of the bearing assembly, such as balls 50 and inner and outer races 42, 52, respectively.

While the representative embodiments illustrating the present invention include a bearing assembly having rolling elements between concentric inner and outer races, those of ordinary skill in the art will recognize that various applications may include devices that do not require rolling elements. For example, the present invention may be implemented by a conductive grease filled bushing assembly for various low speed applications to provide at least one conductive path to a rotating element. The particular construction of a grease filled bushing may vary by application. In general, a grease filled bushing assembly according to the present invention includes at least one bushing with at least one seal or similar device to generally contain the conductive grease to an annular gap between the bushing and rotating element. Bushing assemblies may also include two concentric annular or cylindrical members with an annular gap therebetween filled with a conductive lubricant. A seal is connected to at least one of the members to contain the conductive lubricant and allow rotation of the members relative to one another.

As also shown in FIG. 1, electrically conductive inner race 52 is connected to a lead wire 62 that terminates in connector 66 to supply electric current from an external source during actuation of device 10. Similarly, bearing assembly 46 includes a conductive inner race having a lead wire 64 terminating in connector 64 to provide a return current path to the external current source. Depending upon the particular application and implementation, a single conductive bearing assembly may be used to supply current to embedded coil 18 with the return current path provided by a conductive mount or mounting assembly. In the illustrated embodiment, conductive bearing assemblies 46, 48 are electrically isolated/insulated by one or more insulators 80. Insulators 80 may extend between bearing assemblies 46, 48 as well as between outer race 42 and driving member 12, and between inner race 52 and shaft 70.

Driven member 14 of EM coupling device 10 is secured for rotation with shaft 70 via fastener 90. Driven member or armature 14 includes an annular magnetic material 92 secured to a spring 94 that biases armature 92 away from rotating member 12 to assist disengagement and reduce or eliminate drag when device 10 is deactivated. In this embodiment, armature 14 includes embedded rings or bands 96 of a friction material to provide a friction surface to increase torque carrying capacity of device 10 after engagement or contact between armature 14 and pulley 12.

In operation beginning from the disengaged position as illustrated on the right side of FIG. 1, rotating member 12 is selectively coupled to armature 14 by selectively supplying current to embedded coil 18 through conductive bearing assembly 46 via wire lead 64 and connector 66. A return current path is provided from coil 18 through wire lead 32, outer race 42, rolling elements 50, conductive lubricant 60, inner race 52, and lead wire 62 to the external current source (not shown). Current supplied to embedded coil 18 generates a magnetic field with a flux path passing through rotating member 12 to armature 14 to move armature 14 against the biasing force of spring 94 toward rotating member 12 until friction surface 96 engages rotating member 12 as shown on the left side of FIG. 1. After engagement, armature 14 rotates with rotating member 12. Coupling device 10 is disengaged by de-energizing the external current source so that the magnetic field produced by embedded coil 18 decreases until the biasing force of spring 94 moves armature 14 away from rotating member 12.

According to the present invention as illustrated by the representative embodiment of an electromagnetic friction clutch in FIG. 1, at least one conductive bearing assembly having conductive lubricating grease may be used to energize or activate a coil embedded in a rotating member of a coupling device eliminating less reliable components, such as slip rings or brushes. Elimination of these components reduces part count or the number of components necessary for construction of the device with a corresponding manufacturing cost reduction. Compared to a fixed coil design, the present invention provides an electrically and magnetically efficient design that may reduce weight and power requirements for a given application and lowers manufacturing costs by eliminating the close tolerance air gap.

FIG. 2 is a cross-section illustrating operation and construction of a magnetorheological (MR) fluid or magnetic particle/powder clutch embodiment of a coupling device according to the present invention. Coupling device 100 includes a driving member 102 selectively coupleable to a driven member 104. Driving or rotating member 102 includes an embedded coil 110 disposed within a pocket or groove of rotating member 102 such that substantially the entire outer surface of coil 100 directly or indirectly contacts rotating member 102 to eliminate any air gaps in the magnetic flux path within rotating member 102. As illustrated in FIG. 2, indirect contact may be provided by a material 112 surrounding the coil wire 114 and having desired magnetic properties. Embedded coil 110 is electrically connected by wire lead(s) 120 to at least one electrically conductive bearing assembly. In the representative embodiment illustrated in FIG. 2, two conductive bearing assemblies 122, 124 are used to provide an electric current supply and return, respectively. As described with reference to the embodiment illustrated in FIG. 1, some applications may only require a single conductive bearing assembly with a return current path provided by a conductive mount or mounting assembly.

Each conductive bearing assembly 122, 124 includes a conductive outer race 130 electrically insulated/isolated from rotating member 102 by one or more insulators 126, which also isolate conductive bearing assemblies 122, 124 from a stationary mounting shaft or assembly (not shown) that supports inner race 134. Conductive bearing assemblies 122, 124 each include a plurality of rolling or roller elements 136 surrounded by a conductive lubricant 138 and contained by corresponding seals 140. Inner race 134 of at least one bearing assembly 122, 124 is connected to a lead wire 142 that terminates at connector 144 to connect an external current source (not shown) to supply electrical current during actuation of device 100. A second lead wire 146 may also be provided and connected to a corresponding inner race and connector 144 to provide a return current path.

Depending on the particular application, a third bearing assembly 150 may be positioned between driving or rotating member 102 and second or driven member 104 to provide additional structural support and allow relative rotation therebetween. Bearing assembly 150 does not require electrical conductivity, but may also be implemented as an alternative conductive path by a conductive bearing assembly if desired.

A flowable magnetic material 154 is disposed in a space between rotating member 102 and second member 104. Flowable magnetic material 154 may be any of a number of suitable magnetic particles/powders or magnetorheological fluids that improve coupling of rotating member 102 and second member 104 during actuation of device 100. One or more seals or baffles 156, 158, 160 operate to substantially contain the flowable magnetic material in the space between members 102 and 104.

Magnetorheological fluid and magnetic particle clutches and brakes are often used in applications where slip must be tolerated, i.e. where the driven member rotates at a lower speed than the driving member when the clutch is engaged, or to provide a soft start/engagement. In these applications, heat generated by the frictional slip may be many times greater than resistive heat generated by operation of the coil and the additional heat must be dissipated. Prior art clutch/brake designs that have one or more air gaps generally try to reduce the size of the air gap due to the effect on the magnetic and corresponding electric efficiency. However, small air gaps limit air circulation and the efficacy of forced-air convective cooling. In addition, the air gaps also inhibit conductive cooling. Use of one or more conductive bearings according to the present invention allows the coil to be embedded in the rotating member and eliminates one or more air gaps to improve conductive cooling and corresponding heat dissipation so that slip tolerances can be significantly increased.

In operation, coupling device 100 provides selective coupling between rotating member 102 and second member 104 by supplying an electric current to embedded coil 110 through at least one conductive bearing assembly 124 having conductive lubricant 138. Coil 110 generates a magnetic field that passes through rotating member 102, flowable magnetic material 154, and second member 104 to couple second member 104 to rotating member 102.

As such, the present invention reduces part count and variable cost by using conductive lubricating grease in at least one bearing to provide a direct electrical current path to a rotating electromagnet coil. A direct connection through the bearing and grease eliminates brushes and/or slip rings and may therefore substantially improve reliability and durability. Positioning the coil within one of the rotating members eliminates air gaps in the magnetic flux path to improve magnetic and corresponding electric efficiency so that a smaller, lighter coil with lower power requirements and less generated heat may be used. Elimination of air gaps also reduces manufacturing costs by eliminating tight-tolerance machining operations while improving heat conduction and clutch cooling such that higher slip tolerances may be accommodated for MR fluid and magnetic power clutch applications.

While the best mode for carrying out the invention has been described in detail, those familiar with the art to which this invention relates will recognize various alternative designs and embodiments for practicing the invention as defined by the following claims.

What is claimed is:

1. An electromagnetic coupling device for selectively coupling a rotating member to a second member, the coupling device comprising:
a coil embedded in the rotating member and having an outer surface substantially entirely contacting the rotating member;
at least one assembly having a first electrically conductive annular element electrically coupled to a connector for supplying an electric current from an external source during actuation of the device, a second electrically conductive annular element concentrically positioned relative to the first conductive annular element to create an annular gap therebetween, the second element being electrically coupled to the coil, electrically conductive lubricant disposed in the gap between the first and second annular elements, and a seal extending between the first and second annular elements to contain the conductive lubricant.

2. The electromagnetic coupling device of claim 1 wherein the embedded coil is electrically coupled to a conductive mount to provide a return current path during actuation of the device.

3. The electromagnetic coupling device of claim 1 wherein the at least one assembly comprises two electrically isolated bearing assemblies and wherein the second bearing assembly comprises:
a third electrically conductive annular element electrically coupled to the connector for supplying a return current path to the external source;
a fourth electrically conductive annular element electrically coupled to the coil;
a plurality of rolling elements positioned between the third and fourth annular elements;
electrically conductive lubricant surrounding the plurality of rolling elements; and
a cage positioned between the third and fourth annular elements to contain the plurality of rolling elements and conductive lubricant.

4. The electromagnetic coupling device of claim 3 wherein the second member comprises an annular disk having at least a portion made of magnetic material and surrounding a friction surface disposed between the second member and the rotating member to increase torque transmission during actuation of the device.

5. The electromagnetic coupling device of claim 1 wherein the second member comprises a magnetic armature including a friction surface disposed between the second member and the rotating member to increase torque capacity of the device during actuation.

6. The electromagnetic coupling device of claim 1 further comprising:
a bearing assembly positioned between the rotating member and the second member to allow relative rotation therebetween;
a flowable magnetic material disposed between the rotating member and the second member; and
at least one seal between the rotating member and the second member to substantially contain the flowable magnetic material.

7. The electromagnetic coupling device of claim 6 wherein the flowable magnetic material comprises a magnetic powder.

8. The electromagnetic coupling device of claim 6 wherein the flowable magnetic material comprises a magnetorheological fluid.

9. The electromagnetic coupling device of claim 1 wherein the electrically conductive lubricant has a volume resistivity of less than or equal to about 300 ohm-cm.

10. A method of making an electromagnetic coupling device including a first member selectively coupleable to a second member by a magnetic field generated during actuation of the device, the method comprising:
embedding a coil within the first member such that the first member contacts substantially the entire outer surface of the coil; and
connecting the embedded coil to at least one conductive bearing assembly having conductive lubricating grease to provide electric current through the at least one bearing assembly during actuation of the device.

11. The method of claim 10 further comprising connecting the embedded coil to a conductive device mount to provide a return current path during actuation of the device.

12. The method of claim 10 further comprising connecting the embedded coil to a second conductive bearing assembly having conductive lubricating grease to provide a return current path during actuation of the device.

13. The method of claim 10 wherein the step of connecting comprises:
connecting the embedded coil to an outer race of the at least one conductive bearing assembly; and
connecting an inner race of the at least one conductive bearing assembly to a connector for connection to an external current source.

14. The method of claim 10 further comprising disposing a flowable magnetic substance in a sealed space between the first and second members.

15. The method of claim 14 wherein the flowable magnetic substance comprises a magnetorheological fluid.

16. The method of claim 14 wherein the flowable magnetic substance comprises a magnetic powder.

17. The method of claim 10 further comprising positioning a friction material on at least one surface extending between the first and second members.

18. A method for electrically coupling a rotating member to a second member, the method comprising:
selectively supplying current to the rotating member through at least one conductive assembly having a conductive annular element with at least one surface surrounded by conductive lubricant extending between the annular element and at least one of the rotating member and the second member.

19. The method of claim 18 wherein the rotating member includes an embedded coil having an electrically insulated outer surface substantially entirely contacting the rotating member to provide thermal conductivity, the method further comprising:
coupling the embedded coil to an external current source through a second conductive assembly having a second annular member with at least one surface surrounded by a conductive lubricant.

20. The method of claim 18 further comprising:
coupling the embedded coil to a conductive mounting assembly to provide a return current path.
